(19) United States
(12) Patent Application Publication
(10) Pub. No.: US 2015/0163348 A1
(43) Pub. Date: Jun. 11, 2015

(54) Debug Line Tracer

(71) Applicant: GENBAND US LLC, Frisco, TX (US)

(72) Inventor: Donald L. Fisher, JR., Raleigh, NC (US)

(73) Assignee: GENBAND US LLC, Frisco, TX (US)

(21) Appl. No.: 14/098,365

(22) Filed: Dec. 5, 2013

(51) Int. Cl. H04M 3/22; H04W 40/24; H04W 24/00

(52) U.S. Cl. CPC H04M 3/2281; H04W 24/00; H04W 40/24

(57) ABSTRACT

Systems and methods for a debug line tracer for telecommunication networks are described. In an illustrative, non-limiting embodiment, a method may include requesting via a computer interface, by a user operating a computing device, that a trace processor initiate a call trace operation. The method may also include originating a call to a phone number in response to an indication from the trace processor that a call trace set up procedure has been completed for the phone number. In some cases, requesting that the trace processor initiate the call trace operation may further include providing an indication of the phone number to the trace processor, sending a call trace request to the trace processor, and, in response to the indication that the call trace set up procedure has been completed for the phone number, transmitting a command that the call trace operation be initiated.

### TECHNICAL FIELD

This disclosure relates generally to telecommunications, and more specifically, to systems and methods for a debug line tracer for telecommunication networks.

### BACKGROUND

In telecommunications, the term “call tracing” refers to procedures whereby a user may obtain information about the routing of data for an established connection. In some instances, a “call trace” or “call trace log” may identify an entire route traversed by a call, from its origin (that is, the calling party) to its destination (the called party).

Broadly speaking, there are two types of call tracing. “Permanent call tracing” traces each and every call from the same originating phone number, whereas “on-demand call tracing” enables tracing of a specific call upon request. Traditionally, these call tracing operations have involved both the end user and support personnel communicating on a conference bridge. Support personnel setups the trace and then verbally instructs the user to dial the failing number so that a log may be captured. The inventor hereof has recognized, however, that the traditional approach requires multiple parties to be tied up in the conference at the same time, and involves the manual issuing of a number of commands individually executed to setup the trace. Accordingly, to address these, and other concerns, the inventor hereof has developed systems and methods for a debug line tracer.

### SUMMARY

Embodiments disclosed herein are directed generally to systems and methods for a debug line tracer for telecommunication networks. In an illustrative, non-limiting embodiment, a method may include: requesting via a computer interface, by a user operating a computing device, that a trace processor initiate a call trace operation; and originating a call to a phone number, by the user, in response to an indication from the trace processor that a call trace set up procedure has been completed for the phone number. For example, the computer interface may include a web interface and/or dialing the phone number may include operating a communication device distinct from the computing device. Moreover, the requesting and originating may occur without any interaction between the user and support personnel.

In some implementations, requesting that the trace processor initiate the call trace operation may include providing via the computer interface, by the user operating the computing device, an indication of the phone number to the trace processor; sending via the computer interface, by the user operating the computing device, a call trace request to the trace processor; and in response to the indication that the call trace set up procedure has been completed for the phone number, transmitting via the computer interface, by the user operating the computing device, a command that the call trace operation be initiated.

The method may also include recording via the computer interface, by the user operating the computing device, a file name of a file containing a call trace log resulting from a performance of the call trace operation. For example, requesting that the trace processor initiate the call trace operation may include accessing a unified communications server, and the unified communications server may be coupled to the trace processor. The call may be initiated via a call server, and the call trace operation may be set up when the trace processor establishes a session with the call server.

In another illustrative, non-limiting embodiment, a call trace system may include a processor and a memory coupled to the processor, the memory configured to store program instructions executable by the processor to cause the computer system to: receive from a customer, via a computer interface and in the absence of interaction with support personnel, a request to initiate a call trace operation; set up the call trace operation in response to the request; and provide an indication to the customer, via the computer interface and in the absence of interaction with support personnel, that a call trace set up procedure is completed.

In some cases, the computer interface may include a web interface provided by a unified communication portal. To receive the request, the program instructions may be further executable by the processor to cause the call trace system to: receive from the customer, via the computer interface and in the absence of interaction with support personnel, an indication of a phone number; receive from the customer, via the computer interface and in the absence of interaction with support personnel, a call trace request corresponding to the phone number; and receive from the customer, via the computer interface and in the absence of interaction with support personnel, a command that the call trace operation be initiated after the call trace set up procedure is completed.

In some cases, the computer system may receive the command after the customer has dialed the phone number to originate a call. To dial the phone number the customer operates a communication device distinct from the computer interface. Further, to set up the call trace operation, the program instructions may be further executable by the processor to cause the call trace system to access a debug port of a call server.

In yet another illustrative, non-limiting embodiment, a tangible computer-readable storage medium may have program instructions stored thereon that, upon execution by a communications system, cause the communications system to: receive from a customer of support personnel, via a computer interface accessible to the customer and in the absence of interaction with the support personnel, a request to initiate a call trace operation; transmit the request to a call trace processor; receive, from the trace processor, an indication that call trace set up procedure is completed; and provide the indication to the customer via the computer interface and in the absence of interaction with the support personnel.

In some implementations, the program instructions may further cause the communications system to receive from the customer, via the computer interface and in the absence of interaction with the support personnel, an indication of a phone number; receive from the customer, via the computer interface and in the absence of interaction with the support personnel, a call trace request corresponding to the phone number; receive from the customer, via the computer interface and in the absence of interaction with the support personnel, a command that the call trace operation be initiated after the call trace set up procedure is completed; and provide the indication of the phone number, the call trace request, and the command to the call trace processor.

In some cases, the communications system may receive the command after the customer has dialed the phone number to originate a call, and/or to dial the phone number the customer operates a communication device distinct from the computer interface. Also, the call trace processor may be configured to access a debug port of a call server to execute the command.

### BRIEF DESCRIPTION OF THE DRAWINGS

Reference will now be made to the accompanying drawings, wherein:

FIG. 1 is a block diagram of an example of a telecommunications environment where systems and methods described herein may be implemented according to some embodiments.

FIG. 2 is a block diagram of examples of debug line tracer modules executable by various communication and computing devices according to some embodiments.

FIG. 3 is a flowchart of an example method of executing debug line tracer operations according to some embodiments.

FIGS. 4-8 are example screenshots of a web interface of a debug line tracer tool accessible to a user or customer according to some embodiments.

FIGS. 9-11 are example screenshots of a web interface of a debug line tracer tool accessible to support personnel according to some embodiments.

FIG. 12 is a block diagram of an example of a computer system configured to implement various systems and methods described herein according to some embodiments.

### DETAILED DESCRIPTION

Embodiments disclosed herein are directed generally to systems and methods for a debug line tracer for telecommunication networks. The term “telecommunications,” as used herein, is intended to encompass voice communications or telephony, as well as other forms of communications (e.g., video communications, videoconferencing, instant messaging or IM, Short Messaging Service or SMS, emails, etc.) that may take place electronically, for example, over wireless networks, circuit-switched networks, packet-switched networks, or any combination thereof.

In some implementations, the various systems and methods described herein may include one or more tools configurable to assist an end user or customer in debugging their own network. These tools may provide the end user with the ability to perform trace and/or debug operations to create a log which may then be automatically placed as pending for support personnel to review and/or troubleshoot.

As such, these systems and methods may allow the customer itself to trigger a tracing operation to create a log which can efficiently and timely gather information for use by technical support personnel. Rather than having to first call a technical support hotline, for example, and asking support personnel to use a command line (or perform other operation for triggering a debug trace) the end user may, through a web interface, a native application, or the like, trigger the capture of the log for the problem call and then reproduce that call to have the log automatically captured. Detailed reports for translations, if so desired, may also be provided through the web interface.

In some situations, the customer may enter the phone number they are having issues with and, once the trace is setup, he or she may dial that phone number to reproduce the failure. Once reproduced, the customer may notify support personnel of the file name used to capture the log (e.g., via email, phone call, etc.), and the support person may then be able to diagnose the failure in real-time. Additionally or alternatively, the debug tool may itself notify the support personnel of the file name for the captured log, along with the customer name (identifying the customer who performed the debug trace), etc., without requiring the customer to take action for notifying the support personnel of this information. As such, in contrast with the traditional approach to call tracing outlined above, the systems and methods described herein may, in some cases, eliminate or reduce the need for both parties (the customer and the support person) to be tied up and may also automate a number of commands that would otherwise have to be individually executed to setup trace operation(s).

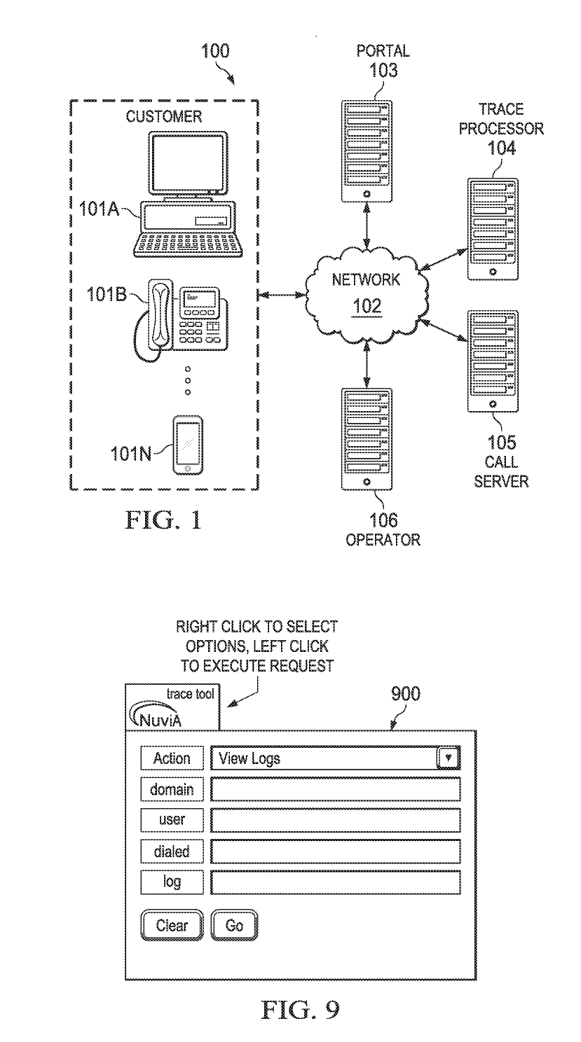

Turning now to FIG. 1, a block diagram of an example of a telecommunications environment where systems and methods described herein may be implemented according to some embodiments. As illustrated, one or more communication devices 101A-N including, but not limited to, analog telephones, digital telephones, teleconferencing systems, desktop computers, network appliances, cellular phones, smartphones, tablet computers, netbooks, and/or laptops, are coupled to telecommunications network 102.

In various embodiments, network 102 may include one or more wireless networks, circuit-switched networks, packet-switched networks, or any combination thereof to enable communications between two or more of devices 101A-N and/or 103-106. For example, network 102 may include a Public Switched Telephone Network (PSTN), one or more cellular networks (e.g., third generation (3G), fourth generation (4G), Long Term Evolution (LTE) wireless networks, etc.), satellite networks, computer or data networks (e.g., wireless networks, Wide Area Networks (WANs), metropolitan area networks (MANs), Local Area Networks (LANs), Virtual Private Networks (VPN), the Internet, etc.), or the like.

Other entities shown in FIG. 1 include unified communications portal 103, trace processor 104, call server 105, and operator system 106. Briefly, unified communications portal 103 may include one or more computer systems and/or networking components configured to provide services such as, for example, messaging, multimedia conferencing and collaboration, mobility, Voice-over-IP (VoIP), and/or desktop integration application(s). Trace processor 104 may include one or more computer systems and/or networking components configured to interact with receive call trace instructions via unified communications portal 103 and to communicate with call server 105 to perform one or more call trace operations. Call server 105 may include one or more computer systems and/or networking components configured to provide call services such as, for example, VoIP services to customer device(s) 101A-N. Operator system 106 may include one or more computer systems and/or networking components configured to allow a telecommunications operator to provide and/or manage services and support features to customers operating device(s) 101A-N.

Here it should be noted that the telecommunications environment of FIG. 1 is shown by way of example only, that the various systems and methods described may be implemented in other ways in other embodiments. For example, in some implementations, certain operations performed by trace processor 104 may be downloadable or otherwise implemented at customer device 101A in the form of a monitoring application. In that case, upon detection of a certain call failure or the like, the monitoring application may automatically re-try of the call with the trace processor monitoring the re-try to capture a log to be sent to technical support personnel. Additionally or alternatively, the monitoring application may send a notification to the user to consider initiating a re-try of the failed call with the trace processor activated.

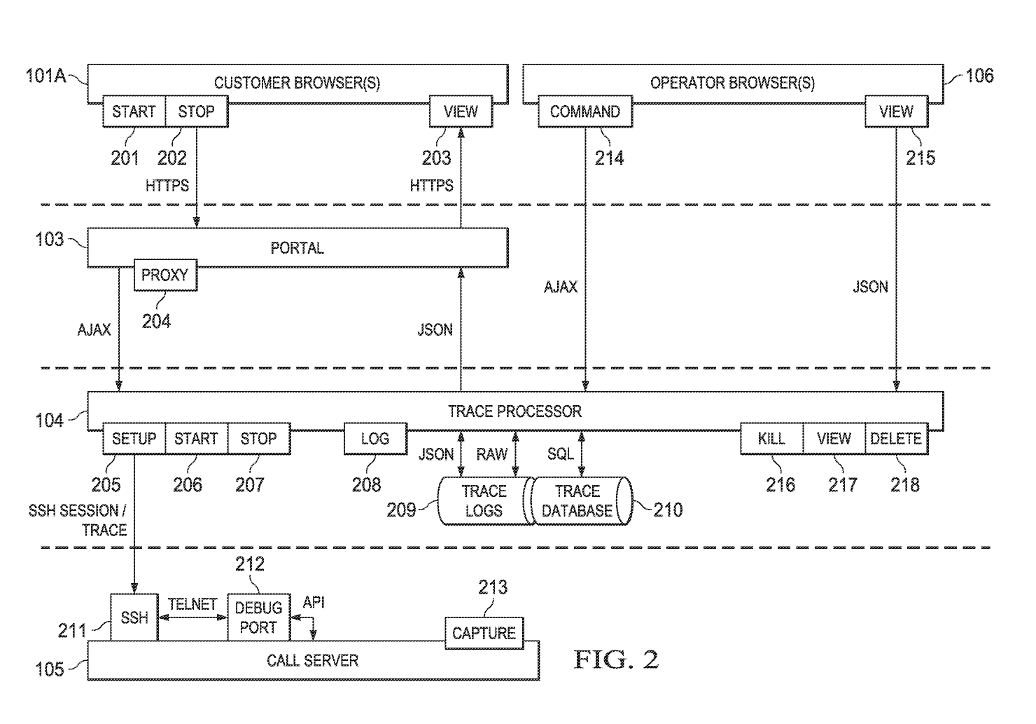

FIG. 2 is a block diagram of examples of debug line tracer modules executable by various communication and computing devices according to some embodiments. As shown, customer device 101A may execute a browser or native application with call trace start module 201, call trace end module 202, and call trace view module 203. Operator system 106 may include call trace command module 214 and view module 215. Unified communications portal 103 may include proxy module 204. Trace processor 104 may include call trace setup module 205, call trace start module 206, call trace stop module 207, call trace log module 209, trace logs 209, trace database 210, kill module 216, view module 217, and delete module 218. Call server 105 may include an Application Program Interface (API) having Secure Shell (SSH) module 211 configurable to communicate with debug port 2120, for example, via a Telnet connection, as well as call trace capture module 213.

In some implementations, modules 201-203 of customer device 101A may communicate with module 204 of unified communications portal 103 using the Hypertext Transfer Protocol Secure (HTTPS) protocol or the like. Module 204 of unified communications portal 103 may communicate with modules 205-210 and 216-218 of trace processor 104 using Asynchronous JavaScript and Extensible Markup Language (XML) (AJAX) and/or JavaScript Object Notation (JSON) tools, for example. Modules 214 and 215 of operator system 106 may also communicate with modules 205-210 and 216-218 of trace processor 104 using AJAX and/or JSON. Modules 205-210 and 216-218 of trace processor 104 may communicate with modules 211-213 of call server 215 via an SSH session or the like.

In some embodiments, the modules or blocks shown in FIG. 2 may represent sets of software routines, logic functions, and/or data structures that, when executed by a processor-based device, perform various operations described in more detail below. Although these modules are shown as distinct logical blocks, in other embodiments at least some of the operations performed by these modules may be combined in to fewer blocks. That is, while shown as distinct blocks in FIG. 2 for ease of illustration and discussion purposes, the numerous blocks may not be separate, distinct identifiable blocks or modules in a given implementation. Although shown with a particular configuration, in other embodiments these various modules or blocks may be rearranged in other suitable ways as will be readily apparent to a person of ordinary skill in the art in light of this specification. For example, one or more of the modules described above may be implemented as a native application executable by a customer's computer.

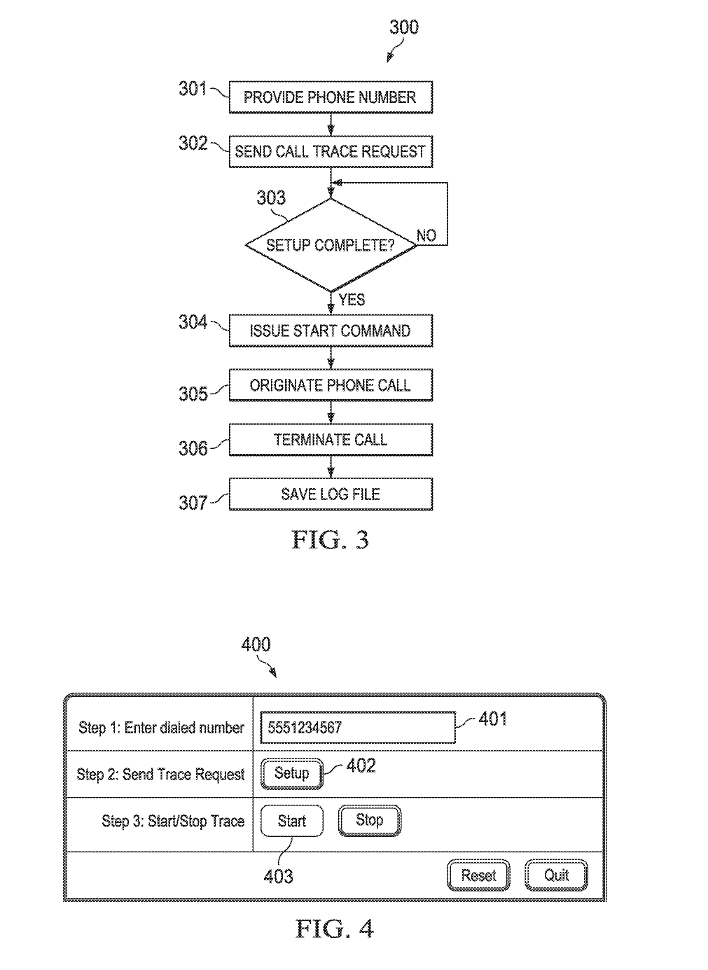

FIG. 3 is a flowchart of an example method of executing debug line tracer operations and FIGS. 4-8 are example screenshots of a web interface of a debug line tracer tool accessible to a user or customer. In some embodiments, method 300 may be performed by modules 201-218 of FIG. 2. As shown, at block 301, a user or customer accesses a computer interface via computing device 101A such as, for example, a web interface provided by portal 103, and enters a phone number corresponding to call to be traced. In some cases, portal 103 may verify that the phone number is valid. Referring to FIG. 4, screenshot 400 shows an example of a web interface where the user has entered a particular phone number 401. The web interface may be rendered, at least in part, via view module 203 of computing device 101A. The web interface also includes send trace request control 402 and start/stop trace control 403.

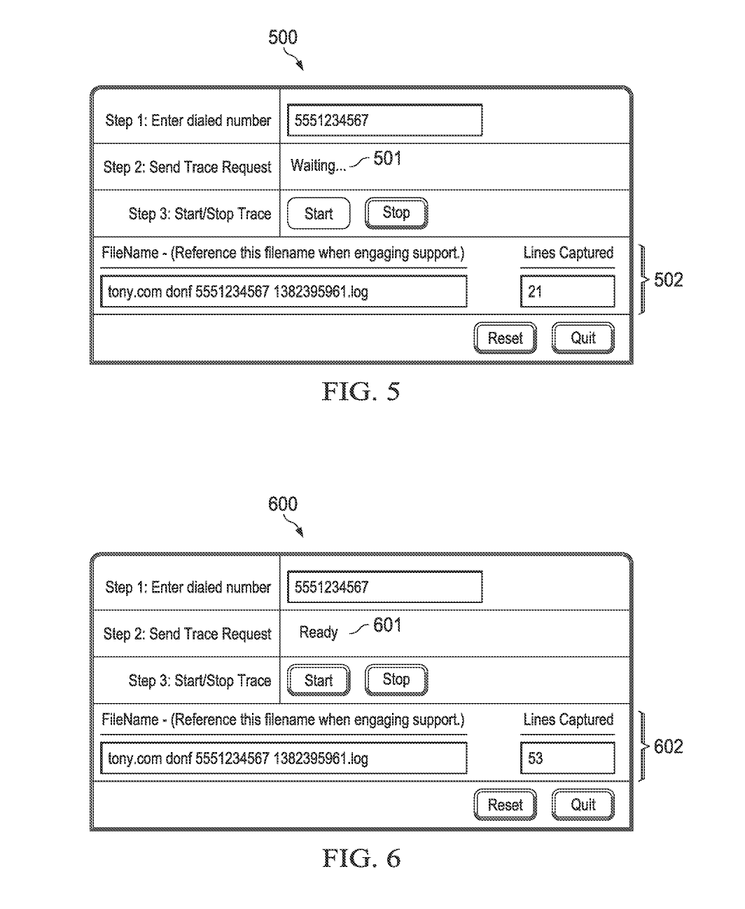

In response to the user's actions at block 301, portal 103 receives, via proxy module 204, an indication of the provided phone number. At block 302, the user or customer sends a call trace request. In FIG. 5, screenshot 500 includes “waiting” indication 501 showing that the user has activated (e.g., clicked on) set trace request control 402. In response, module 204 of portal 103 sends phone number 401 and request 402 to setup module 205 of trace processor 104 as a web service command to initiate a trace job. The command causes trace processor to reach the correct SIP domain for this customer and the username initiating the trace. Then, setup module 205 of trace processor 104 communicates with debug port 212 of call server 105 via SHH module 211 to initiate a call trace set up procedure.

As the call trace setup procedure is being performed, information 502 about the resulting call trace log file such as, for example, a filename and a number of lines captured is displayed on the web interface. In this example, the customer filename indicates the SIP domain is “tony.com.” The username of the user or customer initiating the trace procedure is “donf.” The phone number to be traced is “9194579616.” The time is EPOCH “1382395961,” and the number of lines in the log file is currently 21.

Block 303 of method 300 determines whether the trace call setup procedure is completed by call server 105 and/or trace processor 104. For example, portal 103 may, via Ajax requests, poll trace processor 104's web interface until it finds the trace spawn in a ready or failed state. If ready, the user is updated that the trace is setup and ready to be activated. Particularly, indication 601 of screenshot 600 in FIG. 6 shows that the call trace tool is ready to perform a call trace operation is provided via the web interface. Furthermore, information 602 indicates that additional lines were captured during the setup process. In some implementations, information 602 may continue to be updated in real-time as the trace progresses and as call trace information is captured, thus giving the customer feedback.

At block 304, the user initiates a call trace operation by activating start/stop trace control 403 thereby issuing a start command. At this point, the trace request traverses proxy module 204 of portal 103 and activates start module 206 of trace processor 104, which in turn causes capture module 213 of call server 105 to capture all trace information related to the provided phone number. In some implementations, trace processor 104 spawns a new instance of itself per trace start/stop request. The web interface controls its spawns by updating a “spawns next” command in database 210. If the web interface set the command to quit or leaves a spawn unattended, the instance may self-terminate after a preselected amount of time (e.g., 5 minutes).

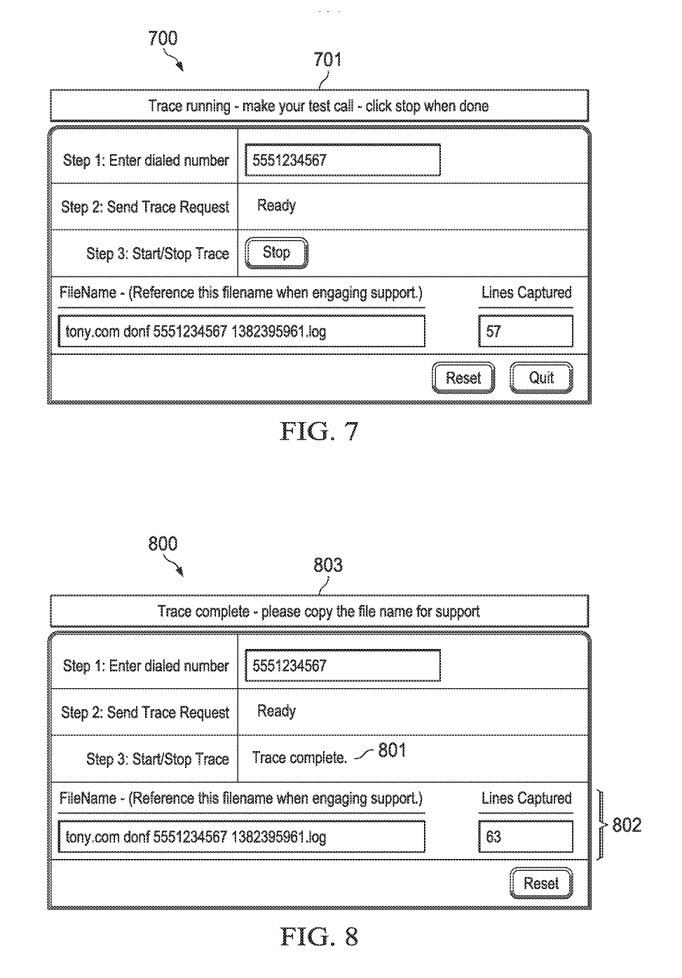

FIG. 7 shows screenshot 700 providing instructions 701 to the user to dial phone number 401 to initiate a test call, for example, using one of communication devices 101A-N. In some cases, the user may utilize computer system 101A accessing the web interface to originate the call. Additionally or alternatively, the user may operate a device distinct from computer system 101A, such as communication devices 101B-N, to originate the call.

At block 305, the user dials the phone number to originate the call. Additionally or alternatively, the call may be triggered by a voice command or through entering a textual VoIP call address or the like via a web interface or native application. After the error or issue occurring during the call is reproduced, and/or after the call is terminated by the user (e.g., the user hangs up the phone) at block 306, screenshot 800 of FIG. 8 provides indication 801 that the call trace operation is complete. For example, once the user activates stop module 202 via start/stop controls 403, proxy module 204 of portal 103 sends a corresponding stop command to trace processor 104, and stop module 207 of trace processor 104 causes capture module 213 of call server 105 to cease its capture operations. In some cases, portal 103 may poll trace processor 104's web interface until the status is ready and/or the log is complete.

Screenshot 800 also shows updated information 802 with the number of lines captured during the trace, and instructions 803 that the user copy or otherwise take note of the filename shown in information 802 so that he or she may provide that filename to support personnel at a later time (e.g., via email, by phone, messaging, etc.). At block 307, the user may then save the resulting log file. Particularly, during the call trace operation, log module 210 may coordinate the creation and maintenance of trace logs 209 in trace database 210, and the resulting trace file may be provided to the user via the web interface.

It should be noted that, in various embodiments, the operations of method 300 may be performed by the user without any interaction (e.g., live communications over another phone call, conference bridge, instant messaging, etc.) with support personnel. After the log file is obtained, support personnel may, via operator system 106, access trace processor 104 to perform certain support activities. For example, support personnel may use command module 214 and view module 215 to control kill module 216, view module 217, and delete module 208 of trace processor 104 and to help diagnose, control, and/or correct problems identified based upon the captured log file.

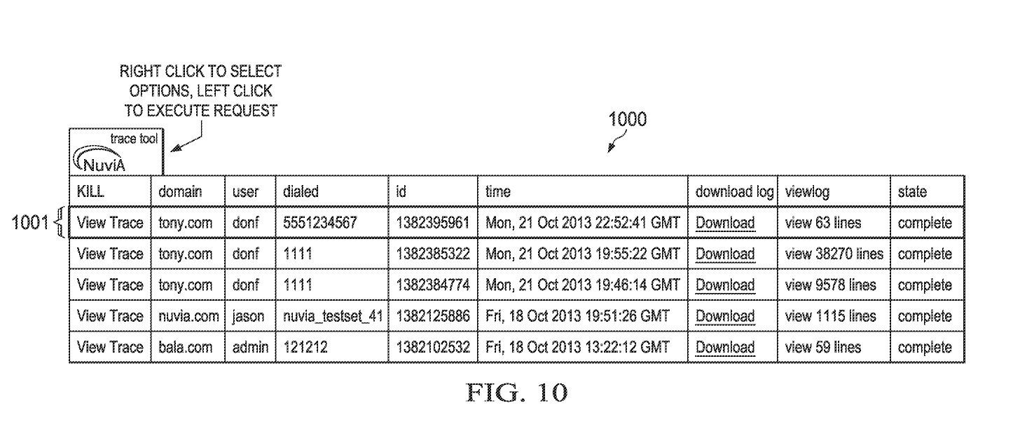

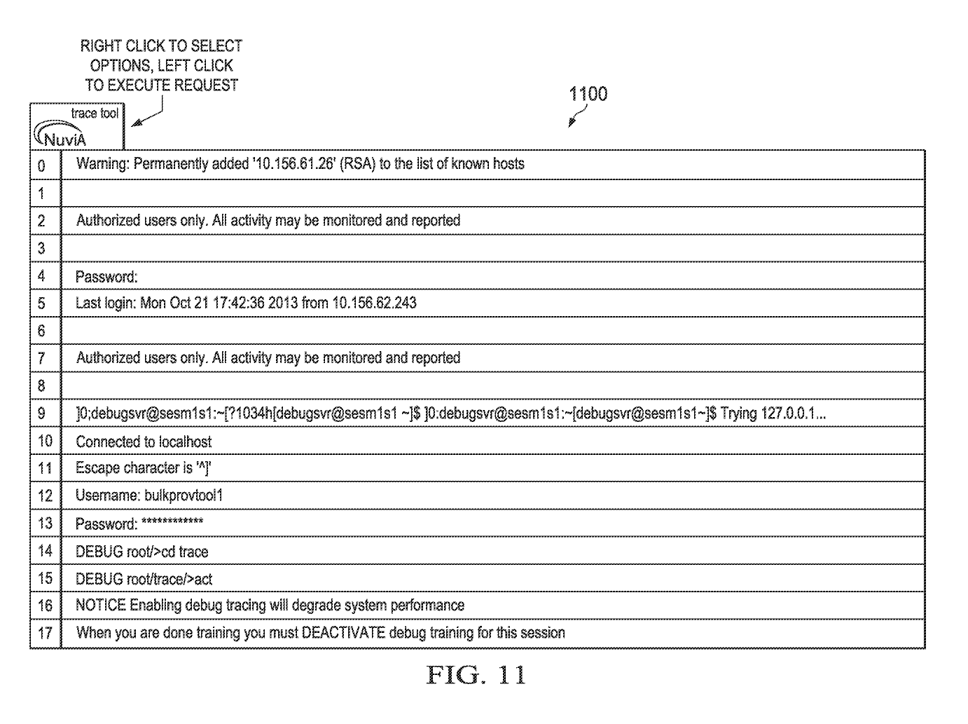

FIGS. 9-11 are examples of screenshots of another web interface of a debug line tracer tool accessible to support personnel via operator system 106. Particularly, FIG. 9 shows a debug line tracer tool 900 enabling a search of call trace log, whereby support personnel may select an action (e.g., view logs) and/or enter parameters such as domain, username, dialed number, or log filename. Once the search is executed, screenshot 1000 of FIG. 10 is an example screenshot of search results. Each entry on the list of call traces includes a domain, username, dialed number, unique identification number, time of capture, link to log file, number of lines in the log file, and state of trace operations (e.g., complete). In this case, the first trace on the list corresponds to the trace executed in the example shown in connection with FIGS. 4-8.

When support personnel clicks on a particular link to a log file, the web interface may render representation 1100 of the selected log file. In this case, the support person clicked view and is reviewing the data via the web interface. In other cases, however, the support person may download the data and review in a text editor of their choice. In response to his or her review of the captured trace data, support personnel may then notify the customer why the call scenario is failing.

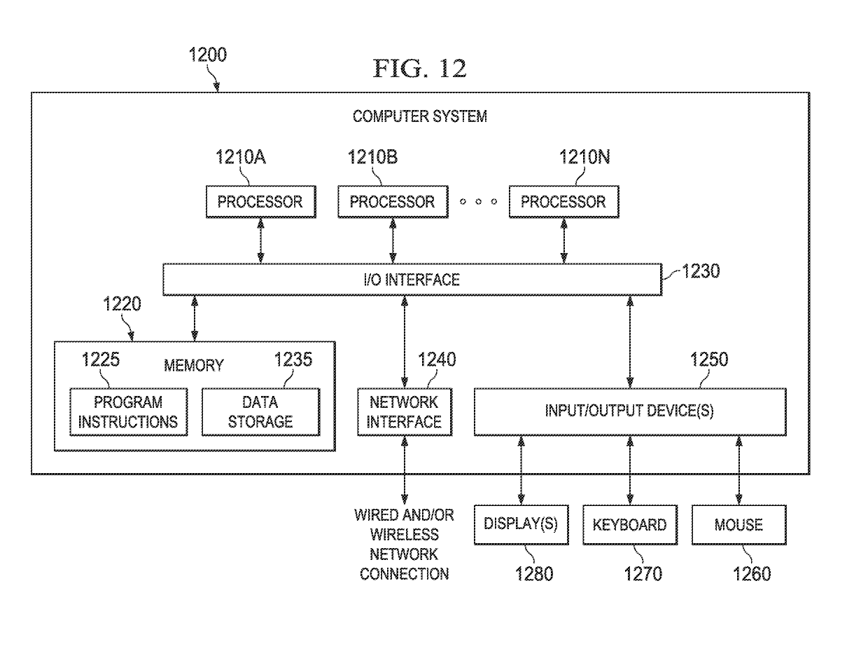

As noted above, embodiments of systems and methods for a debug line tracer may be implemented or executed, at least in part, by one or more computer systems. One such system is illustrated in FIG. 12. In various embodiments, system 1200 may be a server, a workstation, a desktop computer, a laptop, a tablet computer, a mobile device, a smart phone, or the like. In some cases, system 1200 may be used to implement communication devices 101A-N and/or server(s) 103-106 shown in FIG. 1. As illustrated, computer system 1200 includes one or more processor(s) 1210A-N coupled to system memory 1220 via input/output (I/O) interface 1230. Computer system 1200 further includes a network interface 1240 coupled to I/O interface 1230, and one or more input/output devices 1250, such as mouse 1260, keyboard 1270, and display(s) 1280.

In various embodiments, computer system 1200 may be a single-processor system including one processor 1210A or a multi-processor system including two or more processors 1210A-N (e.g., two, four, eight, or another suitable number). Processor(s) 1210A-N may include any processor capable of executing program instructions. For example, in various embodiments, processor(s) 1210A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processor(s) 1210A-N may commonly, but not necessarily, implement the same ISA. Also, in some embodiments, at least one processor 1210A may be a graphics processing unit (GPU) or other dedicated graphics-rendering device.

System memory 1220 may be configured to store program instructions (e.g., software application 200 shown in FIG. 2) and/or data accessible by processor(s) 1210A-N. In various embodiments, system memory 1220 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in connection with FIGS. 3-11, may be stored within system memory 1220 as program instructions 1225 and data storage 1235, respectively. In other embodiments, program instructions and/or data may be received, sent or stored upon different types of computer-accessible media or on similar media separate from system memory 1220 or computer system 1200.

Generally speaking, a computer-accessible medium may include any tangible or non-transitory storage media or memory media such as electronic, magnetic, or optical media—e.g., disk or CD/DVD-ROM coupled to computer system 1200 via I/O interface 1230. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, I/O interface 1230 may be configured to coordinate I/O traffic between processor(s) 1210A-N, system memory 1220, and any peripheral devices in the device, including network interface 1240 or other peripheral interfaces, such as input/output devices 1250. In some embodiments, I/O interface 1230 may perform any necessary protocol, timing or other data transformations to convert data signals from one component (e.g., system memory 1220) into a format suitable for use by another component (e.g., processor(s) 1210A-N). In some embodiments, I/O interface 1230 may include support for devices attached through various types of peripheral buses, such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. In addition, in some embodiments some or all of the functionality of I/O interface 1230, such as an interface to system memory 1220, may be incorporated directly into processor(s) 1210A-N.

Network interface 1240 may be configured to allow data to be exchanged between computer system 1200 and other devices attached to a network (e.g., network 102 of FIG. 1), such as other computer systems, or between nodes of computer system 1200. In various embodiments, network interface 1240 may support communication via wired or wireless general data networks, such as any suitable type of Ethernet network, for example; via telecommunications/telephony networks such as analog voice networks or digital fiber communications networks; via storage area networks such as FibreChannel SANs, or via any other suitable type of network and/or protocol.

Input/output devices 1250 may, in some embodiments, include one or more display terminals, keyboards, keypads, touchpads, scanning devices, RFID readers, NFC readers, voice or optical recognition devices, or any other devices suitable for entering or retrieving data by one or more computer system 1200. Multiple input/output devices 1250 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1240.

As shown in FIG. 12, memory 1220 may include program instructions 1225, configured to implement certain embodiments described herein, and data storage 1235, comprising various data may be accessible by program instructions 1225. In an embodiment, program instructions 1225 may include software elements of embodiments illustrated in the above figures. For example, program instructions 1225 may be implemented in various embodiments using any desired programming language, scripting language, or combination of programming languages and/or scripting languages (e.g., C, C++, C#, Java™, JavaScript™, Perl, etc.). Data storage 1235 may include data that may be used in these embodiments (e.g., recorded communications, profiles for different modes of operations, etc.). In other embodiments, other or different software elements and data may be included.

A person of ordinary skill in the art will appreciate that computer system 1200 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system or processor-based configurations.

Although certain embodiments are described herein with reference to specific examples, numerous modifications and changes may be made in light of the foregoing description. Accordingly, the specification and figures are to be regarded in an illustrative rather than a restrictive sense, and all such modifications are intended to be included within their scope. Any benefits, advantages, or solutions to problems that are described herein with regard to specific embodiments are not to be construed as a critical, required, or essential feature or element of any or all the claims. Furthermore, it should be understood that the various operations described herein may be implemented in software, hardware, or a combination thereof. The order in which each operation of a given technique is performed may be changed, and the elements of the systems illustrated herein may be added, reordered, combined, omitted, modified, etc. It is intended that the embodiments described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as “connected” and/or “in communication with,” although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
requesting via a computer interface, by a user operating a computing device, that a trace processor initiate a call trace operation; and
originating a call to a phone number, by the user, in response to an indication from the trace processor that a call trace set up procedure has been completed for the phone number.

2. The method of claim 1, wherein the computer interface includes a web interface.

3. The method of claim 1, wherein the requesting and originating occur without any interaction between the user and support personnel.

4. The method of claim 1, wherein requesting that the trace processor initiate the call trace operation further comprises:
providing via the computer interface, by the user operating the computing device, an indication of the phone number to the trace processor;
sending via the computer interface, by the user operating the computing device, a call trace request to the trace processor; and
in response to the indication that the call trace set up procedure has been completed for the phone number, transmitting via the computer interface, by the user operating the computing device, a command that the call trace operation be initiated.

5. The method of claim 1, wherein dialing the phone number includes operating a communication device distinct from the computing device.

6. The method of claim 1, further comprising recording via the computer interface, by the user operating the computing device, a file name of a file containing a call trace log resulting from a performance of the call trace operation.

7. The method of claim 1, wherein requesting that the trace processor initiate the call trace operation includes accessing a unified communications server, and wherein the unified communications server is coupled to the trace processor.

8. The method of claim 1, wherein the call is initiated via a call server, and wherein the call trace operation is set up when the trace processor establishes a session with the call server.

9. A call trace system comprising a processor and a memory coupled to the processor, the memory configured to store program instructions executable by the processor to cause the computer system to:
receive from a customer, via a computer interface and in the absence of interaction with support personnel, a request to initiate a call trace operation;
set up the call trace operation in response to the request; and
provide an indication to the customer, via the computer interface and in the absence of interaction with support personnel, that a call trace set up procedure is completed.

10. The call trace system of claim 9, wherein the computer interface includes a web interface.

11. The call trace system of claim 10, wherein the web interface is provided by a unified communication portal.

12. The call trace system of claim 9, wherein to receive the request, the program instructions are further executable by the processor to cause the call trace system to:
receive from the customer, via the computer interface and in the absence of interaction with support personnel, an indication of a phone number;
receive from the customer, via the computer interface and in the absence of interaction with support personnel, a call trace request corresponding to the phone number; and
receive from the customer, via the computer interface and in the absence of interaction with support personnel, a command that the call trace operation be initiated after the call trace set up procedure is completed.

13. The call trace system of claim 11, wherein the computer system receives the command after the customer has dialed the phone number to originate a call.

14. The call trace system of claim 12, wherein to dial the phone number the customer operates a communication device distinct from the computer interface.

15. The call trace system of claim 9, wherein to set up the call trace operation, the program instructions are further executable by the processor to cause the call trace system to access a debug port of a call server.

16. A tangible computer-readable storage medium having program instructions stored thereon that, upon execution by a communications system, cause the communications system to:
receive from a customer of support personnel, via a computer interface accessible to the customer and in the absence of interaction with the support personnel, a request to initiate a call trace operation;
transmit the request to a call trace processor;
receive, from the trace processor, an indication that call trace set up procedure is completed; and
provide the indication to the customer via the computer interface and in the absence of interaction with the support personnel.

17. The tangible computer-readable storage medium of claim 19, the program instructions further cause the communications system to:
receive from the customer, via the computer interface and in the absence of interaction with the support personnel, an indication of a phone number;
receive from the customer, via the computer interface and in the absence of interaction with the support personnel, a call trace request corresponding to the phone number;
receive from the customer, via the computer interface and in the absence of interaction with the support personnel, a command that the call trace operation be initiated after the call trace set up procedure is completed; and
provide the indication of the phone number, the call trace request, and the command to the call trace processor.

18. The tangible computer-readable storage medium of claim 17, wherein the communications system receives the command after the customer has dialed the phone number to originate a call.

19. The tangible computer-readable storage medium of claim 18, wherein to dial the phone number the customer operates a communication device distinct from the computer interface.

20. The tangible computer-readable storage medium of claim 19, wherein the call trace processor is configured to access a debug port of a call server to execute the command.
